(19) United States
(12) Patent Application Publication
(10) Pub. No.: US 2008/0214762 A1
(43) Pub. Date: Sep. 4, 2008

(54) Method for the Production of High-Grade Polyisobutene

(75) Inventors: Andreas Bode, Mannheim (DE); Uwe Rachwalsky, Ludwigshafen (DE); Friedrich Sauer, Obersulzen (DE); Eckard Schauss, Heuchelheim (DE); Marco-Christian Volland, Neuhofen (DE); Thomas Wettling, Limburgerhof (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Basf Aktiengesellschaft, Ludwigshafen (DE)

(21) Appl. No.: 11/994,417

(22) PCT Filed: Jul. 11, 2006
(86) PCT No.: PCT/EP2006/006786

§ 371 Date: Jan. 2, 2008

(30) Foreign Application Priority Data
Jul. 12, 2005 (DE) 102005032440.1

(51) Int. Cl. C08F 4/14; C08F 10/10

(52) U.S. Cl. 526/237; 526/348.7

(57) ABSTRACT

The present invention relates to a process for preparing polyisobutenes by polymerizing isobutene in the presence of a Lewis acid catalyst in liquid organic phase, terminating the reaction by admixing the organic phase with an aqueous terminator in a dynamic mixer which has a rotationally symmetric mixing chamber formed from one circumferential wall and two end walls, and a mixing rotor driven such that it rotates therein, the organic phase being introduced through a first inlet orifice provided in the circumferential wall and the aqueous terminator via a second inlet orifice provided in the circumferential wall, and removing a finely dispersed mixture of the organic phase and of the terminator through an outlet orifice provided in the circumferential wall and feeding it to a phase separation. The process serves to prepare high-reactivity polyisobutenes and/or polyisobutenes with narrow molecular weight distribution.

The present invention relates to a process for preparing polyisobutenes, in particular high-reactivity polyisobutenes and/or polyisobutenes having narrow molecular weight distribution.

High-reactivity polyisobutenes refer to those which have a high content of terminal methylidene groups. In the context of the present application, methylidene groups are understood to mean those double bonds whose position in the polyisobutene macromolecule is described by the general formula

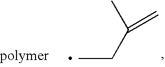

in which “polymer” represents the polyisobutene radical shortened by one isobutene unit. The methylidene groups exhibit the highest reactivity, whereas the double bonds lying further toward the interior of the macromolecules exhibit only a low reactivity, if any, in functionalization reactions. Uses of high-reactivity polyisobutenes include as intermediates for preparing additives for fuels and lubricants.

Such high-reactivity polyisobutenes are obtainable, for example, by the process of EP 0 628 575, by cationic polymerization of isobutene in the liquid phase with the aid of boron trifluoride and of a secondary alcohol at temperatures of from 0° C. to −60° C. Once the desired molecular weight has been attained, the polymerization catalyst is deactivated and the polymerization is terminated in this way. EP 0 628 575 recommends passing the reaction effluent, for this purpose, into a medium such as water, alcohols, acetonitrile, ammonia or aqueous solutions of mineral bases such as alkali metal hydroxide and alkaline earth metal hydroxide solutions, solutions of carbonates of these metals.

For the preparation of high-reactivity polyisobutenes and/or polyisobutenes having a narrow molecular weight distribution, it is critical that, once the desired molecular weight has been attained, the polymerization catalyst is deactivated very rapidly and quantitatively, in order to prevent broadening of the molecular weight distribution and isomerization reactions to give polyisobutene molecules in which the double bond assumes a more thermodynamically favorable position in the interior of the molecule. U.S. Pat. No. 4,849,572 also indicates the requirement for prompt termination of the reaction.

Organic terminators such as acetonitrile and alcohols have the advantage that they are miscible with the organic reaction phase and can therefore be distributed uniformly therein easily. However, they have the disadvantage that their affinity to the BF₃ molecule is comparatively low and they therefore lead only to sluggish catalyst deactivation. Since they can also act as phase mediators, they complicate the subsequent extraction with water to remove the catalyst deactivation products.

Aqueous terminators, especially water itself, have the advantage that the catalyst deactivation and extractive removal of the catalyst deactivation or hydrolysis products can be effected simultaneously. However, a disadvantage is that the aqueous phase is immiscible with the organic reaction phase, and the mass transfer at the phase transfer surface is rate-determining for the catalyst deactivation and the removal of the catalyst deactivation products. Even after the organic reaction phase has been contacted with an aqueous terminator, the polymerization can still continue in an uncontrolled manner and/or undesired isomerizations can proceed. Prompt complete catalyst deactivation and the simultaneous conversion of the catalyst deactivation products from the organic reaction phase into the aqueous phase are therefore crucial for the quality of the resulting polymers which feature a narrow molecular weight distribution, a low content of secondary components, especially of fluorinated secondary components, and/or a high content of terminal methylidene groups. The separation of the aqueous phase laden with deactivation products influences the economic viability of the process.

WO 02/053601 recommends admixing the reaction phase with water in two stages.

It is an object of the present invention to provide an economically viable process for preparing polyisobutenes which have a narrow molecular weight distribution (low dispersity), a low content of secondary components, especially of fluorinated secondary components, and/or a high content of terminal methylidene groups.

According to the invention, this object is achieved by a process for preparing polyisobutenes by
a) polymerizing isobutene in the presence of a Lewis acid catalyst in liquid organic phase,
b) terminating the reaction by admixing the organic phase with an aqueous terminator in a dynamic mixer which has a rotationally symmetric mixing chamber formed from one circumferential wall and two end walls, and a mixing rotor driven such that it rotates therein, the organic phase being introduced through a first inlet orifice provided in the circumferential wall and the aqueous terminator via a second inlet orifice provided in the circumferential wall, and
c) removing a finely dispersed mixture of the organic phase and of the terminator through an outlet orifice provided in the circumferential wall and feeding it to a phase separation.

This procedure very rapidly homogeneously disperses the entire terminator in the organic reaction phase, which results in virtually instant quantitative and uniform catalyst deactivation in one step and simultaneously converts the catalyst deactivation products virtually fully to the water phase. The dispersion thus obtained can be separated in an economically viable manner in a downstream phase separation vessel (calming zone) under gravity, so that both phases are present in coherent form and layered one on top of the other largely without extraneous phases.

Advantageously, the rotational speed of the rotationally driven mixing rotor can be regulated in order to achieve reproducible and uniform properties of the polyisobutene even in the case of varying production load.

In a particularly preferred embodiment, the mean residence time of the organic phase in the dynamic mixer is less than 10 seconds, preferably less than 2 seconds.

The dynamic mixer has a rotationally symmetric mixing chamber which is formed from a circumferential wall and two end walls, at least two entry orifices being provided in the circumferential wall. Within the mixing chamber, a disk-shaped mixing rotor rotates, and preferably has, on its circumference, uniformly distributed edge gaps or paddles.

The organic reaction phase is fed in through a first entry orifice, and all of the terminator is fed in through a second entry orifice which is preferably arranged offset in the direction of rotation of the rotor. The mixture is discharged as a dispersion through an exit orifice on the circumferential wall. Owing to the centrifugal forces generated by the mixing rotor, a liquid ring initially forms in the region of the circumferential wall of the mixing chamber. Between the outlet orifice and the inlet orifices is disposed a baffle in order to prevent delivery back to the inlet.

In preferred embodiments, the mixing rotor has, on its end sides, cutouts which are separated from one another by radial bars, and the mixing chamber has, on its end walls, annular channels which overlap the cutouts in the opposite end walls of the mixing rotor. With the annular channels in the end walls of the mixing chamber, the cutouts form pressure cells which are connected to one another for flow purposes.

Constant pressure increase in the mixing chamber forces liquid into the pressure cells and compresses it, which generates violent turbulence and flow over the mixing rotor. The circulation flow which is established leads, in alternating sequence, to the exchange of the more rapidly circulating liquid contents of the pressure cells with the slower-flowing liquid ring in the region of the circumferential wall. In the course of this operation, energy is transferred by impulse exchange and the turbulence is enhanced further. Owing to this intensive liquid exchange, a particularly homogeneous dispersion forms and subsequently exits continuously from the outlet orifice in the circumferential wall of the mixing chamber.

A particularly preferred dynamic mixer which is suitable for application in the inventive process is described in DE-A 42 20 239, which is fully incorporated by reference. It was surprising that the object underlying the invention is also solved with this mixer which is intended for use to prepare a liquid mixture comprising gaseous constituents if appropriate.

A particularly advantageous design of the entry orifices is that they narrow in a nozzle-like manner in the direction of the mixing chamber. In this way, the organic reaction phase and the terminator pass at high speed into the mixing chamber. The components mix not only as a result of the sudden meeting, but also as a result of a fluidizing effect which is generated by their flow itself. Moreover, the components flow through the mixing chamber more rapidly and more rapid mixing is achieved overall.

In general, from 0.5 to 0.8 part by weight, preferably from 0.2 to 0.6 part by weight of terminator, based on one part by weight of organic reaction phase, is introduced through the entry orifice directly into the circulation flow of the mixing chamber. Together with the organic reaction phase fed in separately, a fine dispersion is obtained, the terminator generally being present as a disperse phase with the aforementioned amount thereof.

According to the invention, the terminator is dispersed in the mixing chamber in the form of droplets of mean diameter of from more than 3 μm to 200 μm, preferably from more than 50 μm to 100 μm, while the organic phase forms the contiguous phase.

The mixing rotor equipped with a drive of controllable rotational speed is operated depending on the throughput of the mixer and rotor geometry such that the energy density is preferably more than 3×10⁵ J/m³, in particular from 5 to 6×10⁵ J/m³. The energy density can be determined, for example, via the power released at the shaft.

The aqueous terminator may comprise dissolved substances such as mineral bases, for example alkali metal hydroxides, alkaline earth metal hydroxides, alkali metal carbonates, alkaline earth metal carbonates, ammonia or acids such as hydrochloric acid, etc. Since, however, no greater advantage is generally associated with this, the terminator preferably comprises no significant amounts of dissolved substances. Tap water or river water is suitable. In general, though, preference is given to demineralized water which is available, for example, in the form of hot steam condensate. The pH is generally in the range from 6 to 10.

The temperature of the terminator is not critical per se. In order that no ice crystals which impair the function of the dynamic mixer form on contact with the organic reaction phase which typically has a temperature of less than 0° C., the terminator is preferably preheated. The terminator typically has a temperature of from 35 to 150° C. Temperatures of more than 100° C. require that the water is kept at a pressure which is higher than ambient pressure.

At the time of introduction into the circumferential wall of the mixer, the organic reaction phase essentially has reaction temperature, i.e., on attainment of the desired degree of polymerization, it is not heated before it is contacted with the circulating terminator in the mixing chamber, when the catalyst is deactivated virtually instantly.

As a result of the contacting of the organic reaction phase with the terminator, the resulting dispersion preferably has temperatures of from 5 to 50° C., in particular from 10 to 45° C.

The dispersion which exits from the mixer is passed into a calming vessel to remove the dispersed water droplets. The phases are appropriately separated in a horizontal phase separation vessel which is flowed through at low flow rate. As a result of the density difference in the coexisting phases, the aqueous phase of higher specific gravity separates as the lower phase from the organic phase. The two phases are present at the exit of the phase separation vessel layered one on top of the other largely free of extraneous phases.

To separate out droplets of the aqueous phase which do not coalesce spontaneously, coalescence-promoting internals may be incorporated into the phase separation vessel. Experience has shown that full separation of uncoalesced droplets requires a very long residence time owing to the density difference, as a result of which economically viable removal is not possible.

The coalescence-promoting internals are random packings, coalescence surfaces or fine-pore internals.

Suitable random packings include the beds of random packings typically used in distillation. Preference is given to passing the entire dispersion through the bed of random packing. As a result of the wetting of the large random packing surface, surface coalescence and simultaneous droplet-droplet coalescence lead to the formation of larger droplets which can then be separated out under gravity without any problem.

The coalescence surfaces are generally ordered plate assemblies which are designed as corrugated or obliquely positioned surfaces on which dispersed droplets accumulate, then form a film, break off as large droplets on the particular plate edge at appropriate film thickness, and then separate out without any problem.

Very fine droplets of the aqueous phase which still remain can be coalesced in an economically viable manner in a downstream phase separation vessel by means of fine-pore coalescence internals, known as coalescence filters, which are designed in the form of filter candles, and then separated out without any problem as larger droplets as in the case of the aforementioned coalescence measures. In the aforementioned fine-pore coalescence internals, the inner structure forces the finely dispersed droplets to come into contact with themselves and with the inner surface of the filter.

Before the further distillative workup of the extraneous phase-free organic phase, it is advantageously subjected to scrubbing with water, which extractively removes dissolved catalyst deactivation products and by-products.

It has been found to be advantageous to link the extractive purification of the organic phase with the ultrafine droplet separation. To this end, before the downstream coalescence measure, the organic phase is admixed with an amount of water, for which experience has shown that from 0.01 to 0.1 part by weight based on the organic phase is sufficient. A preferred extractant is demineralized water.

The workup of the organic phase freed of the aqueous phase to isolate the desired polyisobutene is effected in a customary manner. The polyisobutene is freed, generally by distillation, from unconverted isobutene, inert diluent and, if appropriate, isobutene oligomers, and is obtained as distillation residue, for example as the bottom product of a distillation column.

The polymerization of isobutene is known per se; it can be effected continuously or batchwise, but is preferably effected continuously. Processes for continuous polymerization in the presence of Lewis acid catalysts in liquid organic phase are known per se. In a continuous process, a portion of the reaction mixture formed in the polymerization reactor is discharged continuously. An amount of starting materials, here isobutene or isobutenic feed, corresponding to the discharge is fed continuously to the polymerization reactor. The ratio of the amount present in the polymerization reactor to the amount which is discharged is determined by the circulation/feed ratio which, in the case of continuous polymerization of isobutene to polyisobutene, is generally in the range from 1000:1 to 1:1, preferably in the range from 500:1 to 5:1 and in particular in the range from 50:1 to 200:1. The mean residence time of the isobutene to be polymerized in the polymerization reactor may be from 5 seconds to several hours. Particular preference is given to residence times of from 1 to 30 minutes, in particular from 2 to 20 minutes.

The isobutene is polymerized in the customary reactors such as stirred tanks, tubular reactors, tube bundle reactors and loop reactors, preference being given to loop reactors, i.e. tube (bundle) reactors with stirred tank characteristics. Particularly favorable tubular reactors are those having tubular cross sections which lead to turbulences in partial regions.

The polymerization is carried out at a reaction temperature of from −60 to −4° C., in particular from −25 to −5° C. The heat of polymerization is removed correspondingly with the aid of a cooling apparatus. This can be operated, for example, with liquid ammonia as a coolant. Another means of removing the heat of polymerization is evaporative cooling. In this case, the heat released is removed by partial evaporation of the reaction mixture, for example of the isobutene and/or of other volatile constituents of the isobutene feed or of a volatile diluent. Preference is given to working under isothermal conditions, i.e. the temperature of the liquid organic reaction phase in the polymerization reactor has a steady state value and changes only to a slight degree, if at all, during the operation of the reactor.

The concentration of the isobutene in the liquid reaction phase is generally in the range from 0.2 to 50% by weight, preferably in the range from 0.5 to 35% by weight, based on the liquid organic phase. It depends upon factors including the desired molecular weight of the polyisobutene to be prepared.

Suitable feedstocks are both isobutene itself and isobutenic C₄ hydrocarbon streams, for example C₄ raffinates, C₄ cuts from isobutane dehydrogenation, C₄ cuts from steam crackers, FCC crackers (fluidized catalytic cracking), provided that they have been largely freed of 1,3-butadiene present therein. Suitable C₄ hydrocarbon streams comprise generally less than 500 ppm, preferably less than 200 ppm, of butadiene. The presence of 1-butene, cis- and trans-2-butene is largely uncritical. Typically, the isobutene concentration in the C₄ hydrocarbon streams is in the range from 40 to 60% by weight. When C₄ cuts are used as the starting material, the hydrocarbons other than isobutene assume the role of an inert diluent which is explained below. The isobutenic feed may comprise small amounts of contaminants such as water, carboxylic acids or mineral acids without there being critical yield or selectivity losses. It is appropriate to prevent accumulation of these impurities by removing such harmful substances from the isobutenic feed, for example, by adsorption on solid adsorbents such as activated carbon, molecular sieves or ion exchangers.

Owing to the high viscosity of polyisobutene, it is advantageous to perform the polymerization in the presence of an inert diluent. The inert diluent used should be suitable for reducing the increase in the viscosity of the reaction solution observed during the polymerization reaction to such an extent that the removal of the heat of reaction which arises can be ensured. Suitable diluents are those solvents or solvent mixtures which are inert toward the reagents used. Suitable diluents are, for example, saturated hydrocarbons such as butane, pentane, hexane, heptane, octane, for example n-hexane, i-octane, cyclopentane, halogenated hydrocarbons such as methyl chloride, dichloromethane or trichloromethane, and also mixtures of the aforementioned diluents, among which n-hexane is particularly preferred. The diluents are preferably freed of impurities such as water, carboxylic acids or mineral acids before use, for example by adsorption on solid adsorbents such as activated carbon, molecular sieves or ion exchangers.

The BF₃ concentration in the reactor is generally in the range from 0.005 to 1% by weight, based on the liquid reaction phase, in particular in the range from 0.01 to 0.7% by weight and especially in the range from 0.02 to 0.5% by weight.

Before they are used in the process according to the invention, the boron trifluoride complexes may be preformed in separate reactors, stored intermediately after their formation and metered into the polymerization apparatus as required.

Another preferred variant consists in generating the boron trifluoride complexes in situ in the polymerization apparatus or a feed. In this procedure, the particular cocatalyst, if appropriate together with a solvent, is fed into the polymerization apparatus or the feed, and boron trifluoride is dispersed in the required amount in this mixture of reactants. This converts the boron trifluoride and the cocatalyst to the boron trifluoride complex. Instead of an additional solvent, the reaction mixture composed of unconverted isobutene and polyisobutene can function as the solvent in the case of in situ generation of the boron trifluoride-catalyst complex.

The Lewis acid catalyst is preferably a catalyst based on BF₃ or a BF₃ complex catalyst. In addition to BF₃, these usually comprise one or more cocatalysts.

Boron trifluoride is appropriately used in the form of gaseous boron trifluoride, for which technical boron trifluoride still comprising small amounts of sulfur dioxide and SiF₄, but preferably high-purity boron trifluoride having a purity of about 99.5% by weight, can be used.

The cocatalysts are firstly compounds having an abstractable hydrogen atom. They are referred to as “starters” because their active hydrogen atom is incorporated at the start of the growing polyisobutene chain. Additionally suitable are tert-butyl ethers such as tert-butyl methyl ether which readily form a tert-butyl cation, phenols such as phenol or cresols, or halohydrocarbons such as dichloromethane or trichloromethane. Suitable cocatalysts are, for example, water, methanol, ethanol, 2-propanol, 1-propanol, 2-butanol, sec-pentanol, sec-hexanol, sec-heptanol and/or sec-octanol. Among these, methanol and 2-propanol are most preferred.

The molar ratio of boron trifluoride to cocatalyst is preferably from 1:1 to 1:10, in particular from 1:1.1 to 1:5 and more preferably from 1:1.2 to 1:2.5.

The concentration of the complex of boron trifluoride and cocatalyst in the reactor is generally in the range from 0.01 to 1% by weight based on the liquid organic phase, in particular in the range from 0.02 to 0.7% by weight and more preferably in the range from 0.03 to 0.5% by weight.

Once the desired degree of polymerization has been attained, the organic phase essentially at reaction temperature is treated as described with the terminator.

The process according to the invention is suitable generally for preparing polyisobutenes having a number-average molecular weight of from 500 to 100 000, which are preferably characterized by a high content of methylidene groups and/or a low dispersity.

The expression “content of methylidene groups” relates to the percentage of polyisobutene molecules with methylidene group, based on the number of all olefinically unsaturated polyisobutene molecules in a sample. It can be determined by ¹H NMR and/or ¹³C NMR spectroscopy, as familiar to the person skilled in the art.

Dispersity (uniformity of the molecular weight distribution) is defined as the quotient of the weight-average molecular weight M_{W} and of the number-average molecular weight M_{N}.

The process is particularly suitable for preparing polyisobutenes having a number-average molecular weight of from 500 to 10 000, a content of methylidene groups of more than 60 mol % and a dispersity of from 1.5 to 3.

It is also particularly suitable for preparing polyisobutenes having a number-average molecular weight of from 10 000 to 60 000 and a dispersity of from 1.5 to 3.2.

It is also particularly suitable for preparing polyisobutenes having a number-average molecular weight of from 60 000 to 100 000 and a dispersity of from 2 to 5.

The invention is illustrated in detail by the appended drawing and examples and working examples which follow.

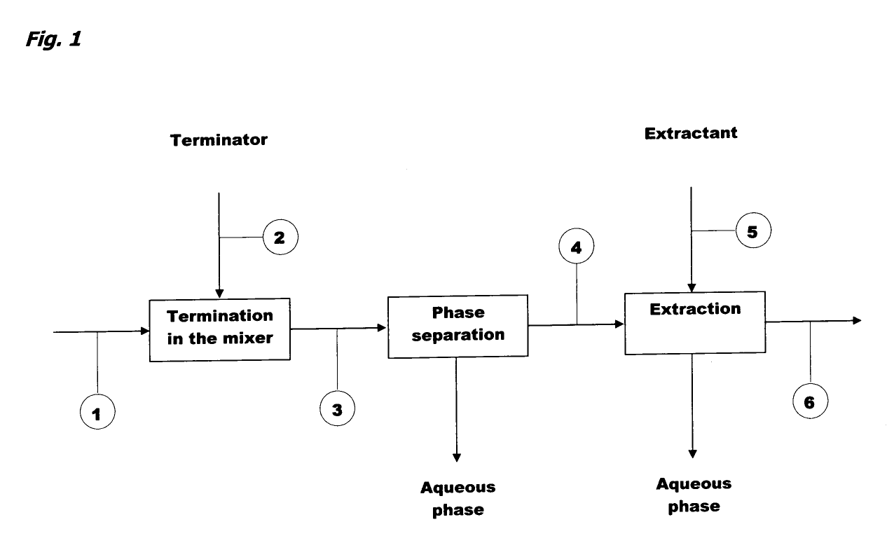

FIG. 1 shows a schematic of the course of workup of the reaction effluent of the isobutene polymerization. The stream designated by “1” is the organic reaction phase which consists essentially of polyisobutene, unconverted isobutene, inert diluent and catalyst. The reaction phase is contacted intimately with the terminator (which is designated by “2”) in a mixer, which deactivates the catalyst and simultaneously extracts the catalyst deactivation products which occur into the aqueous phase. The mixed-phase stream designated by “3” is subjected to a phase separation; the aqueous phase is removed. The organic phase designated by “4” is subjected to a further scrubbing with a preferably aqueous extractant (which is designated by “5”). The unconverted isobutene and the inert diluent are distilled out of the polyisobutene solution designated by “6” in order to obtain the end product.

### EXAMPLES 1 TO 3 (INVENTIVE)

An isobutenic feed was fed in on the suction side of a loop reactor which was equipped with an integrated circulation pump. The boron trifluoride catalyst and the isopropanol cocatalyst were fed in in separate streams. The reactor was cooled such that the temperature in the reaction medium was −15° C. The amount of (co)catalyst and the mean residence time in the reactor were controlled so as to obtain low- or medium-molecular weight polyisobutene of the molecular weight specified in the table below. The isobutenic feed used was either a mixture of about 50% by weight of isobutene and 50% by weight of hexane (“pure isobutene”), or isobutene-comprising raffinate 1 (approx. 40% isobutene, 60% 1-butene, 2-butenes, n-butane and isobutane in different concentrations).

The reactor effluent consisting of the particular polymer, residual isobutene, inert solvent and the boron trifluoride complex was, for the purpose of terminating the reaction, fed directly at reaction temperature into the circumferential wall of a dynamic mixer according to DE-A 42 20 239 at a rotational speed of the mixing rotor of 1500 rpm. The hot condensate used as the terminator was fed separately through the circumferential wall directly into the circulation flow of the mixing chamber. The dispersion obtained from the mixing apparatus was separated in a horizontal phase separation vessel. The subsequent scrubbing by means of hot condensate was associated with the removal of ultrafine water droplets, the dispersion having been separated with the aid of a coalescence filter.

The flow data and quality features of the product are reported in the table which follows, in which the designations “stream 1” etc. relate to the streams shown in FIG. 1.

### EXAMPLES 4 AND 5 (COMPARATIVE EXAMPLES)

In contrast to the aforementioned examples, instead of the dynamic mixer, a static mixer (manufacturer: SULZER) was used, and the organic reaction phase and the terminator were combined at the entrance of the static mixer and the reaction was terminated only as a result of the continuing dispersion along the mixing tube. The polymer solution obtained after termination and phase separation comprises high fluorine contents of 195 and 287 mg/kg. Even after two subsequent extraction steps, it was only possible to remove the catalyst complex incompletely in the coalescence filter after the ultrafine droplet separation (see stream No. 5).

### EXAMPLE 6 (COMPARATIVE EXAMPLE)

In an apparatus arrangement as described in example 4 and 5, the preparation of polyisobutene having mean molar masses of 10 000 and 15 000 daltons was also attempted with a static mixer. For this purpose, the reaction conditions (reaction temperature, composition of the reaction mixture and amount of catalyst) were adjusted to the high molecular weights in advance. The reactor effluent consisted of the particular polymer, about 25% residual isobutene, about 55% inert solvent and the boron trifluoride complex. The dispersity of the resulting polymers was about 7.

### EXAMPLE 7 (INVENTIVE)

The reactor effluent according to example 6 was, for the purpose of terminating the reaction, fed directly into the circumferential wall of a dynamic mixer according to DE-A 42 20 239. The hot condensate which was used as the terminator and had a temperature of 70° C. was fed in a ratio of from 0.2 to 0.6 kg/kg through the second entry orifice in the circumferential wall. The dispersion which was obtained from the dispersion unit and had a temperature of 25° C. was separated into the clear polymer solution and water phase in a phase separation unit with the aid of a coalescence filter. In spite of the high molecular weight of the polymer and the high residual isobutene content, it was possible to remove the fluorine without additional extraction to residual contents of 8-10 mg/kg, and the tert-butanol to residual contents of approx. 10 mg. In contrast to example 6, a low and hence on-spec dispersity of 2.5 was achieved. The polymer solution can be further processed directly without additional extraction steps. According to experience at present, no corrosion problems as in examples 4 and 5 occur in the course of further workup of the polymer solution.

| | | | | | | | | End product |
|---|---|---|---|---|---|---|---|---|
| | | Stream 1 | | | | | | Total fluorine |
| | | Amount | Stream 2 | | | Stream 5 | | Dispersity |
| | Molecular mass (g/mol) | Temperature | Amount | Stream 3 | Stream 4 | Amount | Stream 6 | Methylidene |
| Ex. | Isobutene feed | Total fluorine | Temperature | Temperature | Total fluorine | Temperature | Total fluorine | content |
| 1 | 830-1183 | 4000 kg/h | 1300 kg/h | 20° C. | 6-180 mg/kg | 130 kg/h | 3-6 mg/kg | 0-5 mg/kg |
| | Pure isobutene | −15° C. | 40° C. | | | 40° C. | | 1.7-2.1 |
| | | 1200 mg/kg | | | | | | 82-83 mol-% |
| 2 | 830-1200 | 3300 kg/h | 1300 kg/h | 24° C. | 74-130 mg/kg | 130 kg/h | 80-120 mg/kg | 2-36 mg/kg |
| | Raffinate 1 | −15° C. | 40° C. | | | 40° C. | | 1.6-2.0 |
| | | 2000 mg/kg | | | | | | 60 mol-% |
| 3 | 50000-60000 | 6000 kg/h | 2300 kg/h | 26° C. | — | 80 kg/h | — | ≈1 mg/kg |
| | Pure isobutene | 80 mg/kg | 85° C. | | | 85° C. | | 1.8-3.2 |
| 4* | ≈1000 | | | | 195 mg/kg | | 44 mg/kg | |
| | Pure isobutene | | | | | | | |
| 5* | ≈2300 | | | | 287 mg/kg | | 168 mg/kg | |
| | Pure isobutene | | | | | | | |

*= comparative example

1: A process for preparing polyisobutenes by
a) polymerizing isobutene in the presence of a Lewis acid catalyst in liquid organic phase,
b) terminating the reaction by admixing the organic phase with an aqueous terminator in a dynamic mixer which has a rotationally symmetric mixing chamber formed from one circumferential wall and two end walls, and a mixing rotor driven such that it rotates therein, the organic phase being introduced through a first inlet orifice provided in the circumferential wall and the aqueous terminator via a second inlet orifice provided in the circumferential wall, and
c) removing a finely dispersed mixture of the organic phase and of the terminator through an outlet orifice provided in the circumferential wall and feeding it to a phase separation.

2: The process according to claim 1, wherein the second inlet orifice is arranged offset with respect to the first inlet orifice in the direction of rotation of the rotor.

3: The process according to claim 2, wherein the mixing rotor has paddles spaced apart uniformly on its circumference.

4: The process according to claim 3, wherein the mixing rotor has, on its end sides, cutouts which are separated from one another by radial bars, and the mixing chamber has annular channels on its end walls.

5: The process according to claim 1, wherein the Lewis acid catalyst is a complex of boron trifluoride and at least one cocatalyst.

6: The process according to claim 1, wherein from 0.05 to 0.8, preferably from 0.2 to 0.6, part by weight of terminator, based on one part by weight of organic phase, is introduced.

7: The process according to claim 1, wherein the terminator is present as a disperse phase in the mixture which exits from the outlet orifice of the mixer.

8: The process according to claim 7, wherein the terminator is present in the form of droplets of mean diameter of from more than 3 μm to 200 μm.

9: The process according to claim 1, wherein the energy density to disperse the terminator is more than 3×10⁵ J/m³, preferably from 5 to 6×10⁵′ J/m³.

10: The process according to claim 1, wherein the mixing rotor rotates with a speed of from 500 to 3000 per minute.

11: The process according to claim 1, wherein polymerization is effected in step a) until a polyisobutene having a number-average molecular weight of from 500 to 100 000 is obtained.

12: The process according to claim 11, wherein the polyisobutene has a number-average molecular weight of from 500 to 10 000, a content of terminal double bonds of more than 60 mol % and a dispersity of from 1.5 to 3.

13: The process according to claim 11, wherein the polyisobutene has a number-average molecular weight of from 10 000 to 60 000 and a dispersity of from 1.5 to 3.2.

14: The process according to claim 11, wherein the polyisobutene has a number-average molecular weight of from 60 000 to 100 000 and a dispersity of from 2 to 5.
